(19) United States
(12) Patent Application Publication
(10) Pub. No.: US 2012/0148711 A1
(43) Pub. Date: Jun. 14, 2012

(54) Method for Operating an Installation for Producing Cast Products

(75) Inventors: Bernhard Bauer, Oberuzwil (CH); Peter Braun, Kreuzlingen (CH); Peter Rothenbühler, Kirchberg (CH)

(73) Assignee: BUHLER AG, Uzwil (CH)

(21) Appl. No.: 13/159,556

(22) Filed: Jun. 14, 2011

(30) Foreign Application Priority Data
Jun. 14, 2010 (EP) 10165842.5

(51) Int. Cl. A23G 1/20; A23G 3/02

(52) U.S. Cl. 426/231; 425/162; 426/515

(57) ABSTRACT

An installation for producing cast products includes a tempering machine for at least some of the casting mass, a storage container for the casting mass, a casting machine, and a device for further processing the cast products. At least some of the casting mass is fed to the storage container from the tempering machine, depending on at least one controlling or regulating signal which is based on current and/or expected consumption of casting mass by the casting machine and/or the casting installation. As a result, the installation can be operated at lower cost and extreme fluctuations in the filling level of the storage container can be better prevented, avoiding interruptions in the supply of casting mass to the casting machine.

The invention concerns the technical field of producing cast products, in particular producting confectionery products, such as for example chocolate articles.

Installations for producing cast products, in particular confectionery products, such as for example chocolate articles, are sufficiently well-known per se. Such installations typically comprise at least one tempering machine for at least parts of the casting mass; at least one storage container for the casting mass; at least one casting machine for the casting mass and at least one device for further processing the cast products.

The tempering machine serves for providing the casting mass in a consistency and physical/chemical composition suitable for casting. Often, instead of a comparatively simply constructed tempering machine capable of precrystallizing the casting mass by controlled cooling down and heating up, precrystallizers are also used. In precrystallizers, in addition to the cooling down of the actual stream of raw material, seed material (for example vegetable fat crystal suspension or cocoa butter crystal suspension or partially crystallized chocolate mass) is also admixed in a controlled manner and the complete tempering machine is controlled or regulated in such a way that the subsequent crystallization proceeds more quickly. Suitable methods for precrystallization and corresponding tempering devices are known to a person skilled in the art, for example from the documents DE 102 57 324 and EP 1 180 941.

The casting mass is subsequently transferred into a storage container and subsequently cast with a casting machine. Current practice is for the filling level of the storage container to be monitored. Depending on the filling level detected, the tempering machine is charged: if a lot of casting mass is required, little or no casting mass is circulated through the tempering machine. If, on the other hand, it is indicated by the filling level of the storage container that little or no casting mass is required, little or no casting mass is also fed to the storage container and instead the casting mass is circulated through the tempering machine.

It has been found that the aforementioned procedure is disadvantageous in terms of energy and, in particular when precrystallizers are used as tempering machines, there is a significantly increased requirement for valuable seed material, since, when the casting mass is circulated through the precrystallizer, the degree of precrystallization that has already been achieved cannot be maintained to the full extent.

Moreover, it has been found that the fluctuations in the filling level of the storage container may be very great and, in particular, can occur very quickly; in extreme cases, this may lead to an interruption in the supply of casting mass to the casting machine.

It is therefore an object of the present invention to avoid the disadvantages of the known art, in particular therefore to provide a method and a device which can be operated at low cost and with which extreme fluctuations in the filling level of the storage container can be better prevented, so that in particular interruptions in the supply of casting mass to the casting machine can be avoided.

The aforementioned object is achieved by a method for operating an installation for producing cast products from a casting mass, the installation comprising at least the following components in the direction of product flow:

a tempering machine for at least parts of the casting mass;

a storage container for the casting mass;

a casting machine for the casting mass;

a device for further processing the cast products.

At least parts of the casting mass are fed to the storage container from the tempering machine. According to the invention, the feeding of at least parts of the casting mass from the tempering machine into the storage container is performed in dependence on at least one controlling or regulating signal which is based on the current consumption and/or shortly to be expected consumption of casting mass by the casting machine and/or casting installation.

The casting machine is understood as meaning the machine which deposits the casting mass into the casting moulds. The casting installation, on the other hand, is understood as meaning the entire installation downstream of the casting machine(s) (comprising the casting machine(s), possibly with an integrated storage container for the casting mass), that is to say for example conveyor belts, cooling systems, etc.; the packaging installation is understood as no longer belonging to the casting installation but forming part of the moulding line.

Within the scope of the invention, “shortly” is understood as meaning a time period of ≦30 seconds, preferably ≦120 seconds, particularly preferably ≦300 seconds. The information on the shortly to be expected consumption of casting mass by the casting machine can be obtained in particular by means of linear and/or non-linear extrapolation of actually determined consumptions of casting mass, including for this, for example, actually determined consumptions over a time period of >30 seconds, preferably of >120 seconds; but typically of ≦300 seconds.

The controlling or regulating signal may typically be an “ON” or “OFF” signal for the tempering machine; however, it is also possible within the scope of the invention that the controlling or regulating signal is a signal with which the throughput of casting mass through the tempering machine is set to a value between 0 and the maximum throughput.

According to the invention, a controlling or regulating signal is “based” on the current and/or shortly to be expected consumption of casting mass if it is generated while taking into consideration either the current and/or shortly to be expected consumption of casting mass by the casting machine or casting installation. As a difference from the prior art, therefore, it is not merely a matter of measuring the filling level of the storage container for the casting machine and reacting to this measured filling level, but instead rather a process of using the consumption of casting mass directly to influence the controlling and or regulating of the supply of casting mass from the tempering machine into the storage container. As a result, the installation as a whole can be operated at lower cost, since it is not just a matter of reacting to the static value of the filling level in the storage container, which involves a certain response time and then already possibly necessary, more complex changes to the flow rates of casting mass in the installation. Rather, the controlling or regulating of the installation is proactive, in that the current and/or shortly to be expected consumption of casting mass by the casting machine, that is to say dynamic properties of the part of the installation consuming the casting mass, are used to influence the controlling or regulating of the installation. Response times to fluctuations in the consumption of casting mass can consequently be reduced. Extreme fluctuations in the filling level of the storage container can consequently be better prevented, so that in particular interruptions in the supply of casting mass to the casting machine can be avoided.

The cast products are, for example, fat-containing suspensions, cocoa-containing fatty masses or confectionery; they are preferably chocolate products.

In a particularly preferred embodiment, the tempering machine is a device for producing a seed material (in particular a seed crystal suspension), in particular in an installation for producing chocolate products. In the case of a device for producing seed crystal suspensions, operation that is as uniform as possible while avoiding any unnecessary return of overproduced (currently not required) mass is particularly desired, since in this way the consumption of valuable cocoa butter for producing the seed crystals can be restricted to a minimum. Moreover, just the mass that is fed in, and is consumed by the casting machine or the casting installation, has to be thermally treated. Consequently, fully continuous operation of the entire installation without recycling already tempered casting mass is possible, which lowers the energy requirement of the installation significantly.

The device for further processing the cast products is preferably a device for making up the cast products, in particular a moulding line. If elements of the moulding installations for solid chocolate (for example one or more packaging machines) fail, the requirement for casting mass by the casting machine may suddenly drop very severely, since the operation of the installation is continuous. Especially in such a situation, the reduced response time to changes in the consumption of casting mass by the casting machine are positively noticeable, since overproduction of casting mass can be avoided.

The storage container for the casting mass may be arranged directly upstream of the casting machine in the direction of product flow or else be integrated in the casting machine.

In particularly preferred embodiments, the controlling or regulating signal is generated on the basis of parameters selected from the group comprising (individually or in any combination thereof):

The mass consumption rate and/or volume consumption rate of the casting mass, in particular per casting cycle of the casting machine.

The consumption of casting mass by the casting machine can be determined directly, for example from the consumed mass or the consumed volume of casting mass. Registering the consumption over time allows the current consumption to be easily ascertained, for example in g/min or ml/min, and on this basis also the shortly to expected consumption to be ascertained, in particular by linear extrapolation.

The conveying speed of casting moulds which are filled by the casting machine and transported away.

The casting moulds receive the casting mass that is output, and consequently consumed, by the casting machine. The volume of casting mass that the individual casting moulds can receive can be used as quite a reliable basis for concluding the consumption of casting mass if the conveying speed of casting moulds under the casting machine is also taken into consideration. If, for example, two casting moulds per minute are conveyed under the casting machine, and the individual casting mould has a receiving volume for casting mass of 1000 ml, a consumption of casting mass of 2000 ml/min is obtained.

The mass of cast products produced per unit of time.

The mass of cast products produced may also be used as an indicator of the consumption of casting mass by the casting machine. A weighing module in a transporting-away device (for example a conveyor belt) may, for example, be provided for this. Taking into consideration the conveying speed (see above, b)), the consumption over time can be precisely ascertained from the difference of the (known) weight of the empty casting mould and the weight of the casting mould filled with casting mass; in particular, this can be ascertained more precisely than if, as under b), only the target filling weight of the casting moulds were used.

The further processing rate of the device for further processing the cast products.

The products cast by the casting machine in the casting moulds are further processed, for example decorated, made up or the like; in particular, the further processing may concern packaging. If the amount of products further processed per unit of time is ascertained, this can be used to conclude from the known mass and/or the volume of the individual products the current consumption of casting mass and/or the shortly to be expected consumption of casting mass.

The current output of the tempering machine.

The current output of the tempering machine may be ascertained directly, for example volumetrically or by weighing; preferably, however, the current output of the tempering machine is determined indirectly from the pumping capacity of a pump which delivers the material from the tempering machine into the installation. The current output of the tempering machine is advantageously used as a basis for the controlling or regulating signal, for example as follows: if the ascertained, current or shortly to be expected requirement for casting mass by the casting machine is higher than the current output of the tempering machine, the latter is increased by means of the controlling or regulating signal. If the ascertained, current or shortly to be expected requirement for casting mass by the casting machine is lower than the current output of the tempering machine, the latter is lowered by means of the controlling or regulating signal.

The precalculation of the shortly to be expected consumption of casting mass by the casting machine and/or casting installation.

As already described above, the shortly to be expected consumption of casting mass by the casting machine and/or casting installation may be precalculated, for example by extrapolation, in particular linear extrapolation or non-linear extrapolation. As a result, precalculable changes in the consumption of casting mass by the casting machine and/or casting installation can be particularly effectively taken into consideration at an early time in the charging of the storage container with casting mass.

In preferred embodiments, the at least one controlling or regulating signal may be a signal which is generated in addition to parameters as under a) to f) (individually and in any combination) on the basis of

g) the filling level and/or the change in height of the filling level in the storage container; and/or

h) the filling mass and/or the change in filling mass in the storage container; and/or the filling volume and/or the change in filling volume in the storage container.

It is evident that, in particular, the static values such as filling level, filling mass or filling volume can be expediently used to control or regulate the charging of the storage container expediently. For example, in spite of an ascertained low current consumption of casting mass by the casting machine, for example, the charging of the storage container may nevertheless be increased (for example by increasing the output of the tempering machine) if the filling level, the filling mass or the filling volume is (too) low. In this way, times of low consumption can be used for filling up the stored supply of casting mass. Similarly, in an analogous way, the change in height of the filling level, the change in filling mass or the change in filling volume, that is to say the changes over time, may also be used for the aforementioned control. If the last-mentioned dynamic values are used, a further shortening of the response times is achievable: for example, it is possible when there is a falling filling level to generate the controlling or regulating signal that anticipates the reaching of the permissible lowest level, and prevents shutting down, already on the basis for example of the dynamic change in height of the filling level at a time already before the permissible lowest level in the storage container is reached.

It may be expedient to use the aforementioned filling level parameters g)-i) not only to influence the previously discussed controlling or regulating signal, but possibly to generate a further controlling or regulating signal, which is in particular independent of the other controlling or regulating signal (in particular as under a)-h)); this makes it possible, for example, to set up a safety circuit which generates a signal for controlling or regulating the charging of the storage container in every case in good time before/when a permissible lowest level is reached/fallen below or a permissible highest level is reached/exceeded in the storage container. As described above, the output of the tempering machine may be chosen, for example, as the manipulated variable for this.

A further aspect of the invention concerns an installation for producing cast products from a casting mass, comprising at least the following components in the direction of product flow a tempering machine for at least parts of the casting mass;

a storage container for the casting mass;

a casting machine for the casting mass;

a device for further processing the cast products;

it being possible for at least parts of the casting mass to be fed to the storage container from the tempering machine. The installation is formed in such a way that the feeding of at least parts of the casting mass from the tempering machine into the storage container can be performed in dependence on at least one controlling or regulating signal which is based on the current consumption and/or shortly to be expected consumption of casting mass by the casting machine and/or casting installation.

The basic construction of such installations is sufficiently well-known to a person skilled in the art. The necessary interconnection of the components (and possibly necessary additional components) of the installation in order that the feeding of at least parts of the casting mass from the tempering machine into the storage container can be performed in dependence on at least one controlling or regulating signal which is based on the current consumption and/or shortly to be expected consumption of casting mass by the casting machine and/or casting installation can be easily accomplished by a person skilled in the art. In particular, the logic operations between the individual parameters a)-i) are easily possible to set up in terms of circuitry for a person skilled in the art. If weightings of individual parameters are desired or expedient, these can easily be ascertained by routine tests.

Such an installation fitted out by a person skilled in the art will be operated in the way intended by the method described in detail above.

A further aspect of the invention concerns a computer program product, comprising a computer-readable medium with machine-readable program code, which, when it is run on a computer that is operatively connected to an installation for producing cast products from a casting mass, in particular an installation as described above, operates the installation on the basis of a method as described above.

The logic operations between the individual parameters, which are incorporated in the methods described above for operating an installation, are advantageously fixed in the software on a data carrier. When this data carrier with the software is used in the way intended, the advantages discussed in detail above in connection with the method are manifested in the use of the installation.

A further aspect of the invention concerns a method for converting an installation for producing cast products from a casting mass, the installation comprising at least the following components in the direction of product flow a tempering machine for at least parts of the casting mass;

a storage container for the casting mass;

a casting machine for the casting mass;

a device for further processing the cast products;

and it being possible for at least parts of the casting mass to be fed to the storage container from the tempering machine. The installation is converted in such a way that the feeding of at least parts of the casting mass from the tempering machine into the storage container can be performed in dependence on at least one controlling or regulating signal which is based on the current consumption and/or shortly to be expected consumption of casting mass by the casting machine and/or casting installation.

It goes without saying that a possibly already existing installation can be upgraded by a person skilled in the art, for example by providing it with a computer program product as described above and suitable sensors, for example for the filling level, the weight, volume or the like; the upgrade may also comprise the installation of filling level sensors which generate a signal reproducing the filling level (for example optical systems such as a camera; filling level probes; signal generators from which weight is inferred (for example pressure sensors or weighing modules)). Sensors for the conveying speed of casting moulds or throughflow/throughput sensors may also be installed in order to determine the parameters, in particular under a)-i).

The invention is explained in more detail below on the basis of exemplary embodiments without restricting the subject matter of the invention to the embodiments shown. In the drawing:

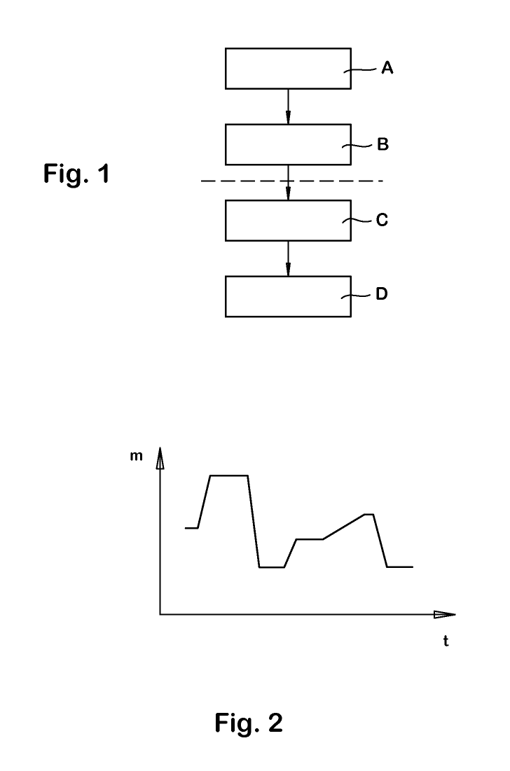

FIG. 1 shows a block diagram of an installation for producing cast products;

FIG. 2 shows the consumption of casting mass by the casting machine over time (by way of example);

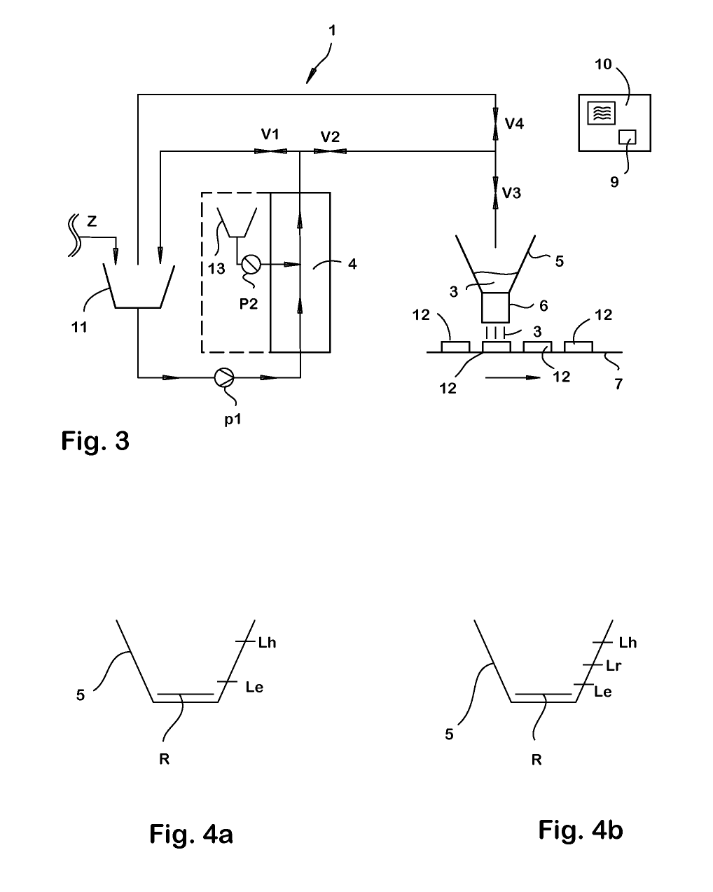

FIG. 3 shows a schematic construction of an installation for producing cast products, with a flow diagram of the raw products and the casting mass;

FIG. 4 a) shows a storage container with two sensors, i. b) shows a storage container with three sensors;

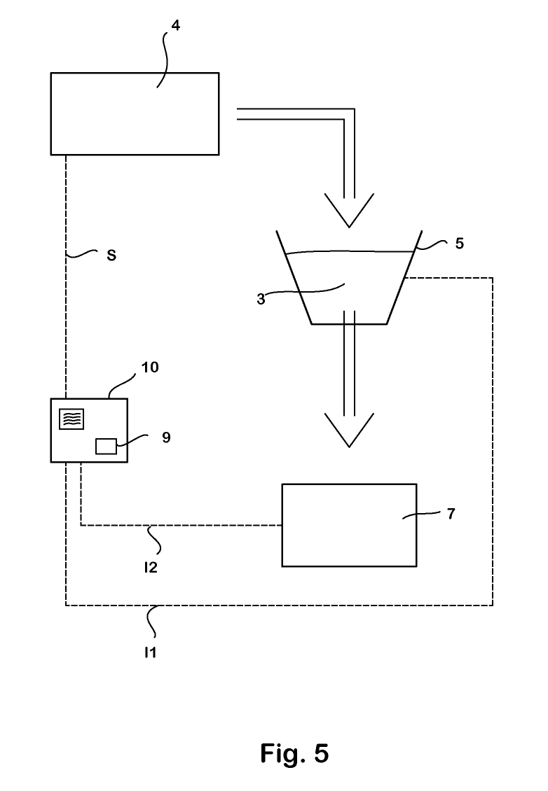

FIG. 5 shows a schematic signal flow in an installation for producing cast products;

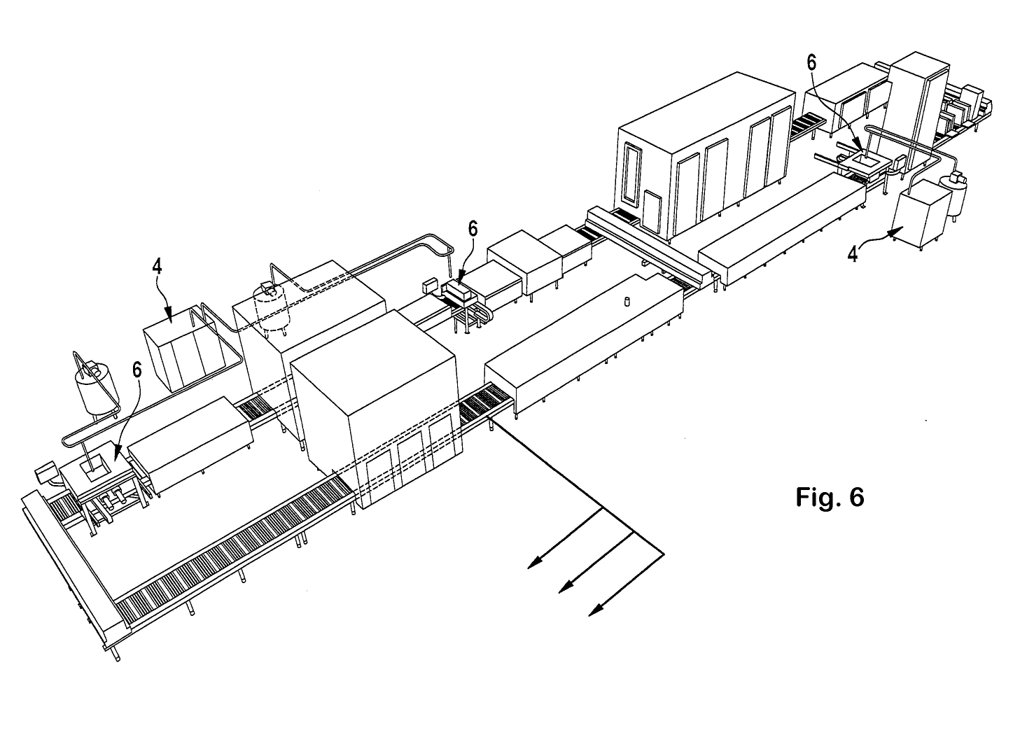

FIG. 6 shows a moulding line (schematically).

FIG. 1 shows the basic construction of a conventional installation for producing cast products. In the case of producing chocolate products, such an installation comprises the functions of
A: feeding in chocolate mass;
B: tempering or precrystallizing; creating a stored supply;
C: casting;
D: further processing.

In the prior art, there is a communication hole between parts C and D on the one hand and parts A and B on the other hand. Although at present the further processing rate is of course adapted to the amount of product cast, and vice versa, the functions A and B are controlled or regulated substantially autonomously, to be precise exclusively on the basis of the filling level in the storage container. However, this (static) filling level does not provide any information on the current and/or shortly to be expected consumption of casting mass by the casting machine; in the prior art it is a matter of only reacting to this when it is manifested in the filling level of the storage container. As a result, the response time in the prior art is greater than in the present invention, with the disadvantages described in detail above.

FIG. 2 shows the consumption of casting mass by the casting machine over time (by way of example). The consumption of casting mass can change quickly, for example if a downstream moulding line has problems. To be able to counter such great fluctuations in the consumption as early as possible by an adaptation of the filling level in the storage container, the present invention has proven to be very advantageous, since response times in the filling of the storage container can be reduced significantly.

FIG. 3 illustrates the schematic flow plan of an installation according to the invention for producing cast products (2; located in the casting mould 12); the diagram shown is—to the extent represented—a configuration according to the invention of the installation. Via a feed Z, chocolate mass, and possibly additional substances, reach the filling container 11. From the latter, the mass is delivered by means of a pump P1 into the tempering machine 4 known per se, which in the exemplary embodiment shown is formed as a device for producing a seed crystal suspension. The seed material produced and/or stored in the tempering machine 4 in the process unit 13 (seed crystal suspension consisting of vegetable fats or cocoa butter or chocolate mass) is admixed with the stream of mass through the tempering machine 4 by means of a pump P2. Via the valves V1, V2, V3 and V4, the casting mass 3 that has been tempered and possibly provided with seed crystals, can be conveyed in a way known per se into the storage container 5. If there is a low requirement for casting mass 3 in the storage container 5, the casting mass may be returned into the filling container 11 via valve V1 or valves V2 and V4 and circulated. Downstream of the storage container 5 is the casting machine 6, which casts the casting mass 3 in casting moulds 12, which are for example located on a conveyor belt and are made to pass under the casting head of the casting machine 6. The casting moulds 12 are fed to the installation 7 for further processing. A computer 10 controls and/or regulates the installation 1, on the basis of a software code stored on a computer program product 9.

In FIG. 4, the storage container 5 is shown in detailed representations, in which filling level sensors are illustrated. Arranged in the lower region of the storage container is an agitator R, which is intended as far as possible always to be completely covered during operation, in order to avoid the undesired inclusion of air. In FIG. 4 a), a variant with only two filling level sensors is shown, namely Lₗ (sensor for the lowest permissible filling level) and Lₕ (for the highest permissible filling level). By means of signals activated by the sensors, the filling of the storage container can be triggered. It is advisable within the scope of the invention to use the signals of these sensors in particular as a safety monitor, in addition to the dynamic consumption value ascertained for the consumption of casting mass by the casting machine. In FIG. 4 b), a variant with an additional filling level sensor Lᵣ is shown; if the reaching of the refill level is detected by the filling level sensor Lᵣ, the filling of the storage container is triggered by a refill signal. If the maximum filling level is reached (response of the filling level sensor Lₕ), the filling is stopped.

In FIG. 5, a controlling or regulating signal according to the invention is schematically indicated in the installation for producing cast products. Casting mass 3 is conveyed from the tempering machine 4 into the storage container 5. The filling level in the storage container 5 is monitored by means of a computer (with a corresponding computer program product, as described above) and controlled or regulated on the basis of the detected filling level of the output of the tempering machine 4, in particular into the storage container 5 (indicated by the input I1). Generated particularly advantageously according to the invention is a controlling or regulating signal S which is based on the current and/or shortly to be expected consumption of casting mass 3 by the casting machine, it being possible, for example, for the consumption of casting mass to be picked up directly at the installation 7 for further processing or ascertained from measured values at this installation 7 (indicated by the input I2).

In FIG. 6, a moulding line is schematically shown. Understood as belonging to the moulding installation for solid chocolate are generally the tempering machine (possibly tempering machines) 4 and the casting machine (possibly casting machines) 6. Moreover, the moulding line usually comprises cooling sections and/or towers and conveyor belts. In the front region, the transporting of the cast products away to three packaging machines is indicated by three arrows; in the present case, the packaging machines are understood as not belonging to the moulding installation for solid chocolate. The casting installation is understood in the present case as meaning the part of the installation downstream of the casting machine (4) (including possibly an integrated storage container for the casting mass), but excluding any packaging machines.

We claim:

1. A method for operating an installation for producing cast products from a casting mass, comprising at least the following components in the direction of product flow:
a tempering machine for at least parts of the casting mass (3);
a storage container for the casting mass;
a casting machine for the casting mass;
a device for further processing the cast products, at least parts of the casting mass being fed to the storage container from the tempering machine, wherein the feeding of at least parts of the casting mass from the tempering machine into the storage container is performed in dependence on at least one controlling or regulating signal which is based on at least one of the current consumption and the shortly to be expected consumption of casting mass by at least one of the casting machine and the casting installation.

2. A method according to claim 1, wherein the cast products are selected from the group comprising fat-containing suspensions, cocoa-containing fatty masses, confectionery and chocolate products.

3. A method according to claim 1, wherein the tempering machine is a device for producing a seed crystal suspension.

4. A method according to claim 1, wherein the device for further processing the cast products is part of a moulding installation for solid chocolate.

5. A method according to claim 1, wherein the controlling or regulating signal is a signal which is generated on the basis of parameters selected from the group comprising:
the mass consumption rate and/or volume consumption rate of the casting mass;
the conveying speed of casting moulds which are filled by the casting machine and transported away;
the mass of cast products produced per unit of time;
the further processing rate of the device for further processing the cast products;
the current output of the tempering machine;
the precalculation of the shortly to be expected consumption of casting mass by at least one of the casting machine and the casting installation;
the change in height of the filling level in the storage container;
the change in filling mass in the storage container;
the change in filling volume in the storage container;
and combinations thereof.

6. A method according to claim 5, wherein the at least one controlling or regulating signal is a signal which is generated in addition on the basis of parameters selected from the group comprising:
the filling level in the storage container;
the filling mass in the storage container;
the filling volume in the storage container;
and combinations thereof.

7. A method according to claim 5, wherein a further controlling or regulating signal is generated on the basis of parameters selected from the group comprising:
the filling level in the storage container;
the change in height of the filling level in the storage container;
the filling mass in the storage container;
the change in filling mass in the storage container;
the filling volume in the storage container;
the change in filling volume in the storage container;
and combinations thereof.

8. An installation for producing cast products from a casting mass, comprising at least the following components in the direction of product flow a tempering machine for at least parts of the casting mass;
a storage container for the casting mass;
a casting machine for the casting mass;
a device for further processing the cast products;
it being possible for at least parts of the casting mass to be fed to the storage container from the tempering machine, wherein the installation is formed in such a way that the feeding of at least parts of the casting mass from the tempering machine into the storage container can be performed in dependence on at least one controlling or regulating signal which is based on at least one of the current consumption and the shortly to be expected consumption of casting mass by at least one of the casting machine and the casting installation.

9. A computer program product, comprising a computer-readable medium with machine-readable program code, which, when it is run on a computer that is operatively connected to an installation for producing cast products from a casting mass, operates the installation on the basis of a method according to claim 1.

10. A method for converting an installation for producing cast products from a casting mass, the installation comprising at least the following components in the direction of product flow a tempering machine for at least parts of the casting mass;
a storage container for the casting mass;
a casting machine for the casting mass;
a device (7) for further processing the cast products (2);
and it being possible for at least parts of the casting mass to be fed to the storage container from the tempering machine, wherein the installation is converted in such a way that the feeding of at least parts of the casting mass from the tempering machine into the storage container can be performed in dependence on at least one controlling or regulating signal (S) which is based on at least one of the current consumption and the shortly to be expected consumption of casting mass by at least one of the casting machine and the casting installation.

11. A method according to claim 10, characterized in that the installation is provided with a computer program product according to claim 9.
